(19) United States
(12) Patent Application Publication
(10) Pub. No.: US 2017/0186119 A1
(43) Pub. Date: Jun. 29, 2017

(54) SYSTEM AND METHOD FOR FACILITATING NON-COMPETITIVE SERVICES NEGOTIATIONS

(71) Applicant: Wes Cameron Martin, Chesapeake, VA (US)

(72) Inventor: Wes Cameron Martin, Chesapeake, VA (US)

(21) Appl. No.: 15/143,469

(22) Filed: Apr. 29, 2016

Related U.S. Application Data
(63) Continuation of application No. 62/155,510, filed on May 1, 2015.

(51) Int. Cl. G06Q 50/18; G06Q 30/06

(52) U.S. Cl. CPC G06Q 50/188; G06Q 30/0611

(57) ABSTRACT

A computer implemented method for facilitating negotiations for services and business transactions that includes engaging an initiating party in communication with an initiated party regarding a service offering, where the parties are engaged for an engagement period. During the engagement period the engaged buyer arrangement is restricted from communicating with other seller arrangements concerning the same or substantially similar subject matter as the currently engaged negotiation. The sameness or substantial similarity of two solicitations from the same buyer arrangement during the engagement period is accomplished by comparing both the attributes of the seller arrangement's service offering and the text and context of the solicitations. Restricting the parties thereby facilitates the parties concluding a negotiation for services.

### CROSS-REFERENCE TO RELATED APPLICATIONS

This patent application claims the benefit of the filing date of U.S. Provisional Patent Application Ser. No. 62/155,510 filed May 1, 2015, which is hereby incorporated by reference in its entirety.

### BACKGROUND OF THE INVENTION

The following description relates to an online non-competitive bidding platform for services whereby solicitors must complete negotiations with one service provider before soliciting a second service provider concerning the same or substantially similar subject matter. Most online lead generating services provide a competitive bidding platform whereby a customer may receive competitive quotes from a plurality of service providers thereby facilitating a sale. Competitive bidding works for many kinds of services, however some kinds of services offer intangible qualities that cannot be justified in the competitive bidding environment. These kinds of services need a platform that restricts competitive bidding so that negotiations are conducted in good faith belief that the solicitor of the services is not just “shopping” the service provider.

Providing a price for services can be costly and time consuming. Thus, simply responding to solicitations is also a hurdle for the online environment. Service providers would like to have a level of security that the customer they are spending resources on is not presently just shopping them for a lower price. For example, some government contracting companies require “Do Not Compete” clauses written into their contracts simply to provide a quote for the work contracted. This exclusivity is favorable for the company and should exist online as well.

This is also an improvement over the prior art of selective negotiations inventions. Many inventions consider the qualifications of the parties involved as the determination of entrance to a negotiations as taught by Yearworth (Application. Ser. No. 10/196,609). The present invention instead looks at the subject matter of engaged negotiations as relevant information.

Jeffrey (U.S. Pat. No. 7,152,037) teaches us that subject matter is relevant for admittance to negotiations. He teaches us that when parties are engaged in negotiations the system restricts communication to the engaged parties to thereby facilitate conclusion of the negotiation. The present invention expands on Jefferies teaching to allow communication selectively based on the subject matter of engaged negotiations. The Jeffrey invention was easily and obviously adapted to selling any presently extant and identifiable goods, teaching that whenever parties are in communication for the sale of a particular item be it a specific house, or potentially a specific car or table, the parties can be restricted from communicating with other potential buyers of that specific good or sellers who would draw the buy away from that specific good.

However, this model cannot be applied to communications and/or negotiations for future services because service people need the freedom to communicate and/or negotiate to sell their non-unique services to others and because the service is not presently extant and identifiable, potential buyer could easily circumvent the Jeffrey's invention by varying the text of their request for services even slightly with no obvious cure.

What is needed is a one sided restriction whereby service people can negotiate with a plurality of buyers, while buyers seeking services are bound to finish talking to one service provider before seeking another, without being forbidden to discuss all services at all. So the current invention allows for a plurality of simultaneous negotiations by the buyers and sellers however, the buyers acting as solicitors are allowed to initiate new negotiations if the subject matter is different and the sellers are unrestricted to negotiate with a plurality buyers when acting as the initiated party.

### SUMMARY OF THE INVENTION

In light of the foregoing background, embodiments of the present invention provide an improved system, method, and computer program for facilitating negotiating for services. The system, method, and computer program of the embodiments of the present invention are capable of permitting solicitors for services (buyers) to initiate communication with service providers (sellers) regarding services offered by sellers. Advantageously, the system, method, and computer program permit the sellers to communicate with a plurality of buyers but the buyer must deal exclusively with a chosen service provider to facilitate the buyer's concluding the negotiations before soliciting another service provider.

The Jeffrey's invention is adapted to selling any presently extant and identifiable goods, teaching us that whenever parties are in communication for the sale of a particular item, be it a specific house, or potentially a specific car or table, the parties can be restricted from communicating with other potential buyers or sellers concerning that specific good. However, this model cannot be applied to communication and/or negotiations for future services because service people need the freedom to communicate and/or negotiate to sell their services to others and because the service is not presently extant and identifiable. A potential buyer could easily circumvent the Jeffrey's invention by varying the text of their request for services even slightly. This invention is adapted to facilitate the beneficial exclusive negotiations system to the service industry by applying the art of comparisons to prevent circumvention and a single sided restriction mechanism to allow service people to continue to contemplate new business during the course of the communications.

According to one aspect of the present invention, a method is provided for facilitating an invitation to negotiate service contracts. In accordance with the method of this aspect, an initiating party is engaged in communication with an initiated party regarding a service offering, where the parties are engaged for an engagement period. In this regard, the initiating party must be a buyer arrangement, with the initiated party being that of a seller arrangement. Before engaging the parties in communication, however, both at least one buyer arrangement and at least one seller arrangement must be registered, where registering the buyer arrangement(s) and seller arrangement(s) includes registering the initiating party and the initiated party.

After engaging the parties, the engaged initiating party is selectively restricted from communicating with other parties concerning the same or substantially similar subject matter during the engagement period. Restriction is based on the subject matter that the engaged parties are engaged in. The other parties being at least one other seller arrangement being solicited by the engaged buyer arrangement concerning the same or substantially similar service(s). As explained below, the engaged buyer can be restricted from communicating with other parties in a number of different manners. Irrespective of how the parties are restricted from communicating with other parties, however, restricting the parties advantageously facilitates the parties concluding the negotiations regarding the service solicitation. In this regard, the method can further include concluding negotiations between the parties regarding the solicitation after restricting the engaged parties from communicating with other parties concerning the same or substantially similar subject matter as the solicitation. Concluding, by methods including but not limited to: agreement on term or withdrawal from communication, would un-restrict the initiating party either fully or in part to communicate with other service providers.

A buyer that includes at least one buyer arrangement may solicit the seller that includes at least one seller arrangement concerning at least one service offering. The engaged initiating party can then be restricted from communicating with other seller arrangements by restricting access to other seller arrangement's communications portals based on identifiers so that restriction is selectively chosen by the computer system. Restriction happens after engaging the parties in communication and thus selectively restricting on subject matter in which the parties are engaged, however, the initiating party is not restricted from the same initiated party from another of the service offerings of the same or substantially similar subject matter. Also, the initiating party is not restricted from initiating another seller arrangement concerning different subject matter from the subject matter the initiating party is currently engaged. Restriction is limited to the initiating buyer and a seller arrangement(s) other than the engaged seller arrangement concerning the same or substantially similar subject matter.

This method and system includes determining a degree of likeness of services to be negotiated. The seller provided service offerings and the buyer provided solicitations with whom communications should be restricted, by providing for the matching of service offerings, whether as a literal match or a non-literal (fuzzy) match. The identifying information may comprise user identities, category, title, and body text of the first service offering as provided by the initiated party. In conjunction with obtaining information from the service offering, the information may also be obtained from the text of the first solicitation as provided by the initiating party. Also, all of the identifying information including historical information may be compared for a degree of likeness thus causing a match signal to be generated.

A match signal may be generated if the identifiers of the second potential solicitation matches the identifiers corresponding to identifiers of the currently engaged negotiations and the match signal may be generated if the identifiers matches one or more of the other similar or synonym identifiers. When the match signal is sent, the user may be notified through their web browser upon requesting a secondary solicitation that the transaction has been denied.

The systems and techniques described here may provide one or more of the following advantages. A system may provide effective and automated checking for communications concerning restricted subject matter for particular parties, without requiring a literal match, and may provide for manual review of any adverse decisions.

Details of one or more implementations are set forth in the accompanying drawings and the description below. Other features and advantages may be apparent from the description and drawings, and from the claims.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for facilitating communications and/or negotiations for a service or services in accordance with embodiments of the present invention;

FIG. 2 is a schematic block diagram of an entity capable of operating as a buyer, seller and/or facilitator, in accordance with embodiments of the present invention;

FIGS. 3A and 3B are flowcharts illustrating various steps in a method of facilitating communications and/or negotiations for a service or services in accordance with an embodiment of the present invention;

FIG. 4 is a block diagram showing various steps to be processed in a method of determining whether a new solicitation is concerning the same or substantially similar subject matter; and

FIGS. 5A and 5B illustrate the practice of restriction concerning same or substantially similar subject matter. The illustrations shows the effect of actions of a buyer restrict access to various service offerings of same or substantially similar subject matter.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

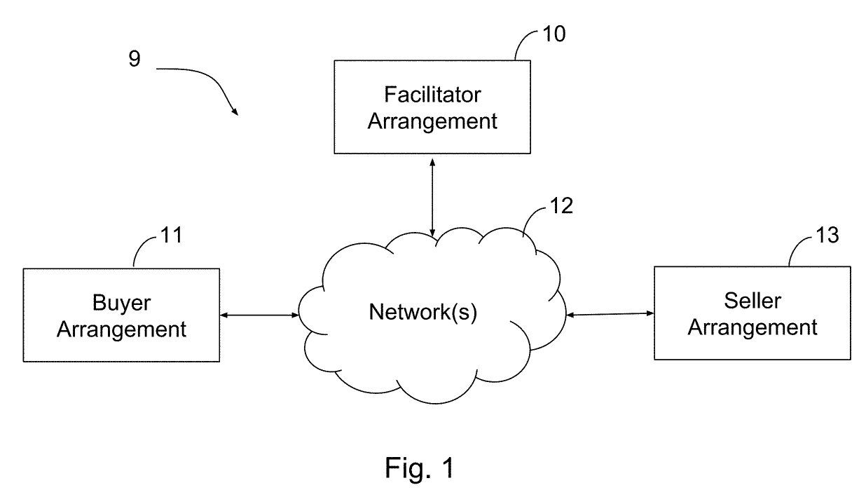

Referring to FIG. 1, a system 9 for facilitating negotiations for services that includes one or more buyer arrangements 11, seller arrangements 13 and facilitator arrangements 10 (one of each being shown). Each buyer arrangement is capable of communicating directly and/or indirectly with one or more seller arrangements and facilitator arrangement. Each seller arrangement can communicate directly and/or indirectly with the facilitator arrangement, but in the preferred embodiment described herein a seller arrangement can only communicate with buyer arrangements indirectly through postings. However, a seller arrangement is capable of communicating directly with any buyer arrangement that initiates direct communication with them; and each facilitator arrangement is capable of directly and/or indirectly communicating with one or more buyer arrangements and seller arrangements. In this regard, the buyer, seller, and facilitator arrangements can be capable of directly and/or indirectly communicating with one another across one or more networks 12. The network(s) can comprise any of a number of different combinations of one or more different types of networks. For example, the network(s) can include one or more data networks, such as a local area network (LAN), a metropolitan area network (MAN), and/or a wide area network (WAN) (e.g., Internet), and include one or more wireline and/or wireless voice networks, including a wireline network such as a public-switched telephone network (PSTN), and/or wireless networks such as IS-136 (TDMA), GSM, and/or IS-95 (CDMA). For purposes of illustration, however, as described below, the network comprises the Internet (i.e., WAN) unless otherwise noted.

The buyer arrangement 11, seller arrangement 13 and facilitator arrangement 10 can comprise any one or more of a number of different entities, devices or the like capable of operating in accordance with embodiments of the present invention. In this regard, one or more of the buyer arrangement(s), seller arrangement(s), and facilitator arrangement(s) can comprise, include or be embodied in one or more processing elements, such as one or more of a laptop computer, desktop computer, server computer or the like. Additionally or alternatively, one or more of the buyer arrangement(s), seller arrangement(s), and facilitator arrangement(s) can comprise, include or be embodied in one or more portable electronic devices, such as one or more of a mobile telephone, portable digital assistant (PDA), pager or the like. For example, the buyer arrangement, seller arrangement and facilitator arrangement can each comprise a processing element capable of communicating with one another across the Internet (e.g., network 12).

It should be understood, however, that one or more of the buyer arrangements 11, seller arrangements, 13 and facilitator arrangement 10 can comprise or otherwise be associated with a user carrying out the functions of the respective entity. For example, the buyer arrangement can comprise a buyer or buyer agent (representing a buyer) communicating across a PSTN (e.g., network 12), by mail or in person with a seller operating a seller processing element, where the seller and processing element collectively comprise the seller arrangement. In such instances, the facilitator arrangement can comprise a facilitator processing element communicating across the Internet with the seller processing element. Alternatively, in such instances, the facilitator can comprise a facilitator operating a facilitator processing element, where the facilitator is capable of communicating with the seller across a PSTN. As explained below, then, the term “buyer arrangement” can refer to a buyer and/or buyer processor. Similarly, the term “seller arrangement” can refer to a seller and/or seller processor; and the term “facilitator arrangement” can refer to a facilitator and/or facilitator processor.

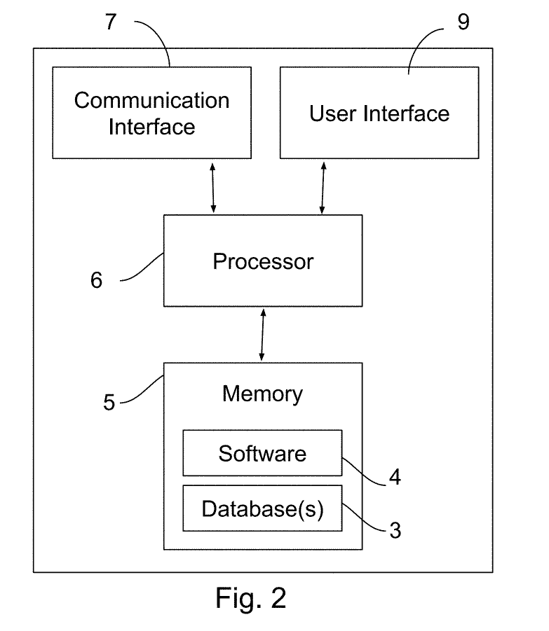

Referring now to FIG. 2, a block diagram of an entity capable of operating as a buyer arrangement 11, seller arrangement 13 and/or facilitator arrangement 10 is shown in accordance with one embodiment of the present invention. Although shown as separate entities, in some embodiments, one or more entities may support one or more of a buyer arrangement, seller arrangement and/or facilitator arrangement, logically separated but co-located within the entit(ies). For example, a single entity may support a logically separate, but co-located, buyer arrangement and facilitator arrangement. Also, for example, a single entity may support a logically separate, but co-located seller arrangement and facilitator arrangement.

As shown, the entity capable of operating as a buyer arrangement 11, seller arrangement 13 and/or facilitator arrangement 10 can generally include a processor 6 connected to a memory 5. The processor can also be connected to at least one communication interface 7 or other means for transmitting and/or receiving data, content or the like. The processor can additionally be connected to a user interface 9 that can include a display and a user input interface. The user input interface, in turn, can comprise any of a number of devices allowing the entity to receive data from a user, such as a keypad, a touch display (not shown) or other input device.

The memory 3 can comprise volatile and/or non-volatile memory, and typically stores content, data or the like. In this regard, the memory typically stores software applications 4, instructions or the like for the processor to perform steps associated with operation of the entity in accordance with embodiments of the present invention. For example, the memory can store software applications such as one or more connectivity applications (e.g., Web browser, etc.). Also, when the entity comprises a facilitator arrangement 10, the memory can store one or more databases 4, such as a buyer database and a service offering database. The buyer database can store information relating to buyers registered with the service offered by the facilitator arrangement, and the service offering database can store information relating to sellers and associated service offerings that are registered with the service.

For the buyers, information regarding the service offerings of the sellers and/or the sellers themselves can be generated, gathered or otherwise received by the facilitator arrangement 10. The facilitator arrangement can then evaluate such seller information to allow the facilitator arrangement to provide data related to the service offerings.

In accordance with embodiments of the present invention, the facilitator arrangement 10 is capable of displaying service offering information to one or more buyer arrangements 11 and seller arrangements 13. Generally, the service provides a medium for buyers to communicate with sellers exclusively based on subject matter to facilitate the respective arrangements concluding a negotiation for a service or services. Buyers are not restricted from being sellers and sellers may be buyers but the distinction is always the abilities of each arrangement. Buyers are permitted to initiate communication through a seller's associated service offering portal. Sellers are only permitted to accept communication requests through their own service offering portals. And as such if a seller initiates contact the same rules would apply for the seller to act as a buyer.

Before, after or as the facilitator arrangement 10 evaluates the buyer information or seller information, the facilitator arrangement can create an entry for the buyer or the seller in the buyer database or seller and/or service offering database. Also, in accordance with the service provided by the facilitator arrangement, the facilitator arrangement can send the buyer arrangements 12 listings of the service offerings of sellers stored in the service offering database as shown in block 24. The listings of service offerings can include any of a number of different pieces of seller information and service offering information, respectively. Here are examples of two typical embodiments: First, the service offering is listed with other service offerings and the seller information is linked to the service offering listing, and second example, the seller is listed and the service offering is linked to the seller listing.

Once the initiating and initiated parties are engaged in communication, the initiating party can be restricted from contacting other parties (i.e., other sellers) for the engagement period (i.e., generally, until the parties agree upon terms or one party ends the communication/negotiation). In this regard, the parties can be considered engaged in communication in any of a number of different manners. For example, the parties can be considered engaged in “communication” for the purposes of enacting restrictions once the initiating party sends the solicitation or when the initiated party accepts the solicitation, or once the initiated party receives the solicitation, etc. For the purposes of the preferred embodiment “communication” and thus restrictions begin once the initiating party sends a solicitation. Irrespective of exactly when the parties are considered engaged in communication, during the engagement period, the buyer can be restricted from communicating with other sellers regarding like (i.e. the same or substantially similar) service offerings. The parties can be restricted from communicating with other parties in a number of different manners. Specifically, there are two manners in accordance with the method of the disclosed invention. First, that portals for service offerings exactly corresponding to the category of negotiated for services are access restricted. Second, if the initiating party sends a solicitation for the same or substantially similar services based on the text and context of the solicitation heading and body, that solicitation is denied delivery. This will be discussed more below.

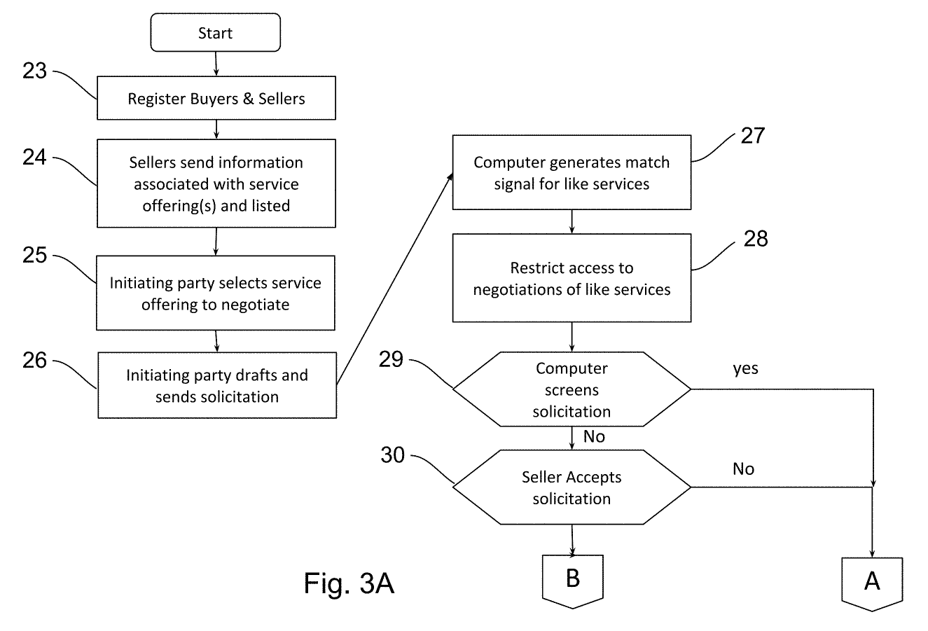

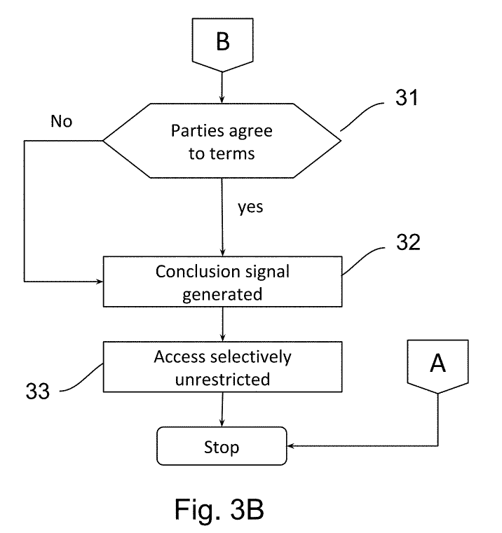

Reference is now made to FIGS. 3A and 3B, which illustrates various steps in a method of facilitating a negotiation for services, in accordance with one embodiment of the present invention. As shown in block 23, the method can include the one or more buyers and sellers of the buyer arrangements 11 and seller arrangements 13, respectively, registering with the facilitator arrangement 10, or more particularly with the service offered by the facilitator arrangement. The registered seller arrangements then send information establishing service offerings 24. These service offerings are listed and displayed for the buyer arrangements. The initiating party selects from the available non-restricted service offerings 25. The buyer arrangement then drafts the solicitation with at least one piece of drafted identifying information that is sent to the seller arrangement associated with the service offering selected 26. Upon sending the solicitation the buyer is engaged in negotiations and the computer generates match signal 27 the computer also restricts like service offerings and is able to screen the solicitation for restricted subject matter. In this way the facilitator arrangement has the ability to deny delivery if the solicitation has a match signal for restricted subject matter 27. If a match signal is generated the solicitation is not delivered. For example, the facilitator arrangement can permit a buyer arrangement to access non-restricted service offerings but may deny delivery after the solicitation has be drafted and sent. One or more pieces of information regarding the negotiations currently engaged can be used as identifiers for the subject matter compared to the identifiers of the solicitation. The access-restricted negotiations information can include any of a number of different pieces of information. If no match signal is generated the solicitation is delivered to the seller. So blocks 27-29 happen after 26 automatically. If the solicitation is delivered, the seller has the option to engage or decline the solicitation 28. If the seller arrangement engages the buyer arrangement.

As shown in FIG. 3B, the facilitator arrangement facilitates the negotiations in order to conclude the negotiations. The negotiations can be concluded when the parties agree or either party leaves the negotiations 31. Once the negotiations are concluded the facilitator arrangement produces a conclusion signal 32. The conclusion signal allows the facilitator to selectively un-restrict the initiating party from restricted access discussed below 33.

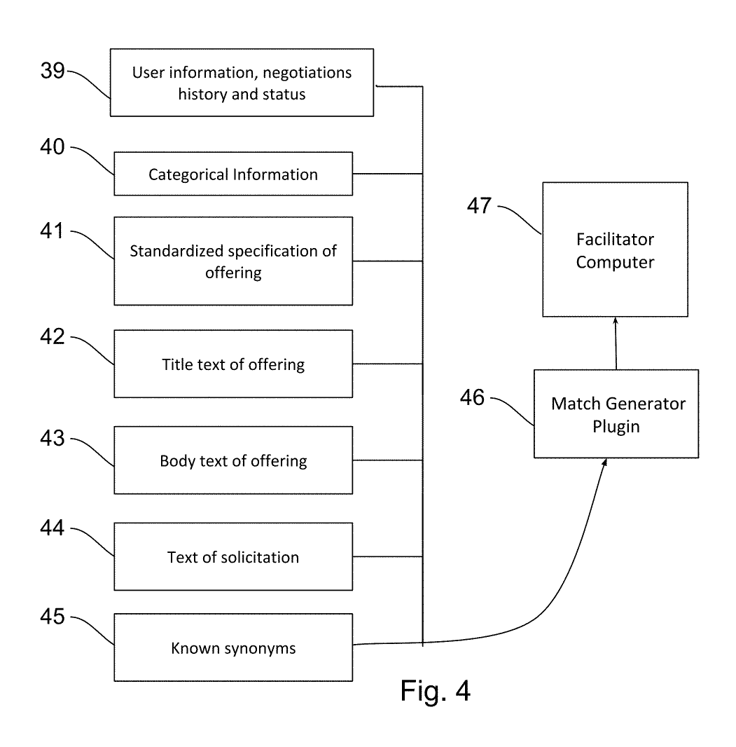

Generally the facilitator arrangement will use a this defined process for acquiring and comparing information. Reference is now made to FIG. 4, The computer gathers information from the available text and context of the negotiations and solicitation. The computer is adapted to use all or a portion of the information available as identifiers to generate the match signal. The computer recognizes the users involved and takes user information and negotiation history including current negotiation status as identifying information 39. The computer then takes any predefined terms such as categorical information 40 and/or standardized specifications of the offering 41. Then the computer gathers any service offering title information 42 and the body text of the offering 43. Information from the seller would include boxes 40-43. The information provided by the buyer is the at least one piece of drafted information as the text of the solicitation 44. The computer then uses the known synonyms and delivers it to the match generator 46. Any match signal is handled by the facilitator computer to restrict access accordingly. The match generator could be a plug-in module and/or part of the facilitator arrangement 47 and it assists the facilitator arrangement in analyzing the information to generate a match for the identified restricted subject matter. However, at least a portion of the identifying information typically comprises information not used in the negotiations such as user information negotiation status and number and subject matter of previously negotiations.

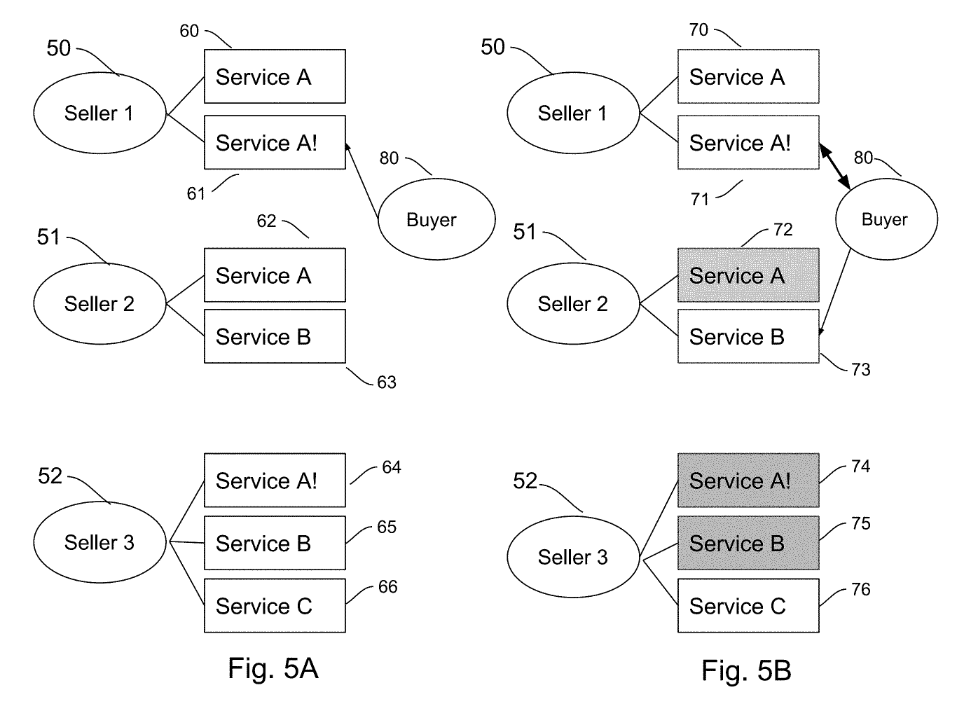

Reference is now made to FIGS. 5A and 5B that show the practice of restriction for like or substantially similar subject matter. FIG. 5A has a plurality of seller arrangements 50-53 and one buyer arrangement 80. In this example, seller 1 (box 50) is offering two service offering portals 60 and 61 respectively. Note that Service A (box 60) and Service A! (box 61) are substantially similar services. And that Seller 2 (box 51) is offering the same service as Seller 1 in this case the service is called Service A (boxes 60 and 62). The buyer solicits Service A! (box 61) from Seller 1 (box 50). Seller 1 accepts the solicitation of the buyer as shown in FIG. 5B. FIG. 5B shows the restriction caused by the action of buyer in FIG. 5A and the action of an additional solicitation shown as a one sided arrow pointing from the buyer to Service B (box 73). FIG. 5B shows service offerings restricted to the buyer as shaded and the services offering unrestricted as not shaded. The restricted service offerings being 72, 74 and 75. The unrestricted service offerings being 70, 73 and 76. The buyer's action in FIG. 5A is to solicit Service A!, this solicitation then restricts the same and the substantially similar services from Sellers 2 and 3, these are shaded boxes 72 and 74. In FIG. 5B the buyer then solicits Service B (box 73) from Seller 2 (box 51). This action then restricts the same service offering from the other seller in the figure offering the same service. In this case it is Seller 3 (box 52) offering Service B (box 75). Notice now that the buyer is unrestricted from only two service offerings, that of Service A (box 70) from Seller 1 (box 53), this is because Service A and Service A! are substantially similar subject matter offered by the same seller as the buyer is already engaged. And Service C (box 76) is unrestricted because it is different subject matter than that which the buyer is currently engaged.

After the initiating and initiated parties are engaged in communication, either of or both of the parties may desire to conclude a negotiation for a service or services regarding a service offering of the seller. In such an instance, the parties can conclude the negotiation for a service or services in any of a number of different manners, such as by entering into an agreement for services regarding a respective service offering, shown in block 31, or one may withdraw from the communication/negotiation. In either event, or any other event that brings the communication to a close, a closing signal is sent and parties are unrestricted.

Similarly the facilitator arrangement can also restrict the buyer arrangement 11 from engaging a seller arrangement that is offering services that the facilitator arrangement has denied access. The facilitator arrangement also denies delivery to drafted solicitations that the facilitator arrangement has identified as restricted subject matter. In this way the facilitator arrangement is protecting the seller arrangement(s) from missed match signals or abuses of the system by the buyer arrangements.

After the initiating and initiated parties are engaged in communication, if the parties can conclude the negotiation for a service or services for the respective service offering (see block 32), the parties can also be selectively unrestricted from block 33. Selective un-restriction could be in the form of denying access to certain subject matter if the buyer arrangement 11 has reached a limitation of access, for example: If the buyer arrangement 11 has negotiated with more than 5 seller arrangements concerning the same subject matter may be prohibited activity. This feature is protection from abuses of the system, for example; a robot may be using the system to mine information. The facilitator arrangement has the ability to protect the users from such abuses.

As will be appreciated, the service of the facilitator arrangement 10 described herein can be provided in a number of different contexts relating to services and service offering, from commercial to consumer services. It should be understood, however, that the service can generally be provided in any of a number of different contexts involving a buyer and a seller of a good.

According to one aspect of the present invention, all or a portion of the system of the present invention, such as all or portions of the buyer arrangement 11, seller arrangement 13 and/or facilitator arrangement 10, generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 3A, 3B and 4 are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowcharts.

Accordingly, blocks or steps of the control flow diagrams support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer implemented method of regulating negotiations comprising: a facilitator arrangement for providing a service to users both service providers and solicitors for services (Solicitors), wherein at least one initiating party comprises a buyer arrangement (Buyer) and at least one initiated party comprises a seller arrangement (Seller) and; the initiated party being selectable from associated service offerings provided by Seller information for Solicitors to make solicitations to negotiate for services (Solicitations); the facilitator arrangement (Facilitator) engaging the parties for an engagement period, and wherein the facilitator arrangement is adapted to restrict the engaged initiating party from communicating with other service providers concerning the same or substantially similar subject matter during the engagement period to thereby facilitate the engaged parties concluding negotiations regarding the Solicitation; analyzing by the computer the text and context of a Solicitation when an initiating party makes a Solicitation for services, the words and contextual information of the Solicitation becomes the identifying information for the resulting communication/negotiation and; comparing with the computer system all or a portion of information to determine a degree of likeness (same or substantially similar subject matter) between any currently active communications/negotiations to any other service offering from another Seller and restricting access to the service offerings of other Sellers with the same or substantially similar service offering as the subject matter as the active negotiation during the engagement period.

2. The method of claim 1, wherein selectable predetermined categories are used as identifiers.

3. The method of claim 2, wherein predetermined synonyms are used as identifiers.

4. The method of claim 3, wherein computer system generates a matching signal if one or more of the identifiers match the identifiers of the service offerings with which access should be restricted.

5. The method of claim 4, wherein a match signal causes access to service offering(s) to be restricted.

6. The method of claim 5, wherein a completion signal selectively unrestricts the initiating party to solicit another service provider concerning the same or substantially similar subject matter as the restricted subject matter identifiers.

7. A computer implemented method of regulating negotiations comprising: a facilitator arrangement for providing a service to users both service providers and solicitors for services (Solicitors), wherein at least one initiating party comprises a buyer arrangement (Buyer) and at least one initiated party comprises a seller arrangement (Seller) and; the initiated party being selectable from associated service offerings provided by Seller information for Solicitors to make solicitations to negotiate for services (Solicitations); the facilitator arrangement (Facilitator) engaging the parties for an engagement period, and wherein the facilitator arrangement is adapted to restrict the engaged initiating party from communicating with other service providers concerning the same or substantially similar subject matter during the engagement period to thereby facilitate the engaged parties concluding negotiations regarding the Solicitation; analyzing by the computer the text and context of a Solicitation when an initiating party makes a Solicitation for services, the words and contextual information of the Solicitation becomes the identifying information for the resulting negotiation and; comparing with the computer system all or a portion of information to determine a degree of likeness (same or substantially similar subject matter) between any currently active negotiations and subsequent Solicitations from the initiating party and restricting subsequent Solicitations from being delivered by the initiating party that have the same or substantially similar subject matter as the active negotiation during the engagement period.

8. The method of claim 7 wherein the text of the solicitation(s) is used as identifiers.

9. The method of claim 8 wherein predetermined synonyms are used as identifiers.

10. The method of claim 9, further comprising generating a matching signal if one or more of the identifiers of restricted subject matter match the identifiers of solicitation.

11. The method of claim 10, wherein a match signal causes delivery of the solicitation to be denied.

12. The method of claim 11, wherein a completion signal selectively unrestricts the initiating party completely or partially to solicit another party concerning the same or substantially similar subject matter as the restricted subject matter identifiers.

13. A computer program product for facilitating non-competitive negotiation for services, the computer program product comprising at least one computer-readable storage medium having computer-readable program code portions stored therein, the computer-readable program code portions comprising: a first executable portion for providing a service to at least one buyer arrangement and at least one seller arrangement, providing the service including providing information relating to at least one buyer arrangement or at least one seller arrangement, wherein one of the buyer arrangements comprises an initiating party and at least one of the seller arrangements comprises an initiated party, the initiated party being selectable from the provided seller information; a second executable portion for engaging the initiating party in communication with the initiated party regarding a service offering; and a third executable portion for restricting the engaged initiating party from communicating with other seller arrangements concerning the same or substantially similar subject matter during the engagement period to thereby facilitate the parties concluding a negotiation for services, the other parties comprising at least one of at least one other seller arrangement, restricting the engaged parties comprising at least one of restricting the the initiating parties from accessing, removing or completion of activity within the service.

14. A computer program product according to claim 13, wherein the third executable portion is adapted to communicate with a match generator plug-in module.

15. A computer program product according to claim 13, wherein the third executable portion is adapted to restrict access to other listings to the initiating party, or restrict access by denial of delivery of communication to other parties.
